(19) United States
(12) Patent Application Publication
(10) Pub. No.: US 2011/0167855 A1
(43) Pub. Date: Jul. 14, 2011

(54) REFRIGERANT HEATING APPARATUS ASSEMBLY AND AN ATTACHING STRUCTURE THEREOF

(75) Inventor: Masahiro Wakashima, Osaka (JP)

(73) Assignee: DAIKIN INDUSTRIES, LTD., Osaka-shi, Osaka (JP)

(21) Appl. No.: 13/063,308

(22) PCT Filed: Sep. 14, 2009
(86) PCT No.: PCT/JP2009/004559

§ 371 Date: Mar. 10, 2011

(30) Foreign Application Priority Data
Sep. 17, 2008 (JP) 2008-238718

(51) Int. Cl. F25B 27/00; H05B 6/10

(52) U.S. Cl. 62/238.7; 219/629

(57) ABSTRACT

A refrigerant heating apparatus assembly includes a copper inner pipe inserted into a magnetic outer pipe and an induction heating coil. The copper inner pipe is expanded such that an outer diameter of the copper inner pipe enlarges and thereby is mated to an interior of the magnetic outer pipe. The copper inner pipe is configured to form part of a refrigerant piping of a refrigerant circuit. The induction heating coil is mounted to an outer circumference of the magnetic outer pipe.

### TECHNICAL FIELD

The present invention relates to a refrigerant heating apparatus assembly and an attaching structure thereof.

### BACKGROUND ART

In the conventional art, there are various methods for heating a refrigerant in a refrigerant circuit; however, from the standpoint of rapidly heating a refrigerant using induction heating, an induction heater (hereinbelow, called an IH heater) is convenient.

In such an IH heater for heating a refrigerant, induction heating is generated by an induction heating coil that magnetically excites a piping wherethrough the refrigerant flows or a magnetic body either inside or outside of the piping, thereby making it possible to heat the refrigerant inside the piping.

Here, on the basis of thermal conductivity, workability, cost of materials, and other factors, copper is normally used as the material of the piping that constitutes the refrigerant circuit. However, the material of the piping heated by the IH heater is preferably magnetic, such as stainless steel, in order to efficiently achieve electromagnetic induction heating.

Accordingly, as in the IH heater disclosed in Patent Document 1 (i.e., Japanese Unexamined Patent Application Publication No. 2001-174054), the outer circumference of a copper pipe is coated with a magnetic paint or powder, which makes it possible to efficiently achieve induction heating even with a copper pipe.

### SUMMARY OF THE INVENTION

### Technical Problem

Here, to further improve the induction heating efficiency, it is conceivable to use a stainless steel pipe as the pipe wherethrough the refrigerant flows inside the IH heater; however, in this case, the stainless steel pipe heated by the IH heater and the copper piping that constitutes the other parts of the refrigerant circuit have different material properties, which creates the following problems.

First, to brazing pipings of different materials to one another, a special brazing material must be used; consequently, a worker with a high level of skill is needed to perform the brazing work, and therefore manufacturing costs increase, which is a problem.

In addition, because different types of metals having different linear coefficients of thermal expansion are connected to one another, their expansion/contraction rates in response to temperature changes are different, and therefore there is a possibility that defects (e.g., cracks) will be created in the brazed portion.

Moreover, if a coil is disposed such that it is directly wound around the outer circumference of the stainless steel pipe, then maintaining the strength of the IH heater will become problematic.

An object of the present invention is to provide a refrigerant heating apparatus assembly that can improve the work efficiency and reliability of a heating piping and the strength of a refrigerant heating apparatus, and to provide an attaching structure thereof.

### Solution to Problem

In a refrigerant heating apparatus assembly according to a first aspect of the present invention, a copper inner pipe, which constitutes part of a refrigerant piping of a refrigerant circuit, is inserted into an outer pipe, which is a magnetic body; the inner pipe is expanded in directions in which its outer diameter enlarges and thereby is mated to the interior of the outer pipe; and, furthermore, an induction heating coil is mounted to the outer circumference of the outer pipe.

Here, a copper inner pipe is inserted into an outer pipe, which is a magnetic body; the inner pipe is expanded and thereby is mated to the interior of the outer pipe; and, furthermore, an induction heating coil is mounted to the outer circumference of the outer pipe; thereby, the inner pipe is made of the same type of material as the other refrigerant pipings, which makes it easy to couple the pipings. Accordingly, because metals of the same type are connected to one another, there is no longer any risk that cracks will be created in the brazed parts as a result of the expansion/contraction rate owing to temperature changes, which improves reliability. As a result, it becomes easy to manufacture the air conditioner, which makes it possible to improve the work efficiency and the reliability of the pipings. Moreover, the outer pipe, which is a magnetic body, enables effective induction heating. In addition, because a structure is adopted wherein the induction heating coil is mounted to the thick outer pipe, the strength of the entire refrigerant heating apparatus assembly is improved.

A refrigerant heating apparatus assembly according to a second aspect of the present invention is the refrigerant heating apparatus assembly according to the first aspect of the present invention, wherein the outer pipe is made of stainless steel.

Here, the outer pipe is made of stainless steel, which makes it possible to perform induction heating effectively; moreover, strength is increased and lifespan is lengthened.

A refrigerant heating apparatus assembly according to a third aspect of the present invention is the refrigerant heating apparatus assembly according to the first or second aspects of the present invention, wherein the wall thickness of the outer pipe is 1-1.2 mm.

Here, the wall thickness of the outer pipe is 1-1.2 mm, and therefore effective induction heating is obtained owing to the skin effect.

In a refrigerant heating apparatus assembly attaching structure according to the fourth aspect of the present invention, the refrigerant heating apparatus assembly according to first through third aspects of the present invention is attached to the refrigerant circuit, wherein the refrigerant heating apparatus assembly is attached to the refrigerant circuit by brazing both ends of the inner pipe of the refrigerant heating apparatus assembly to a copper refrigerant piping of the refrigerant circuit.

Here, the refrigerant heating apparatus assembly is attached to the refrigerant circuit by brazing both ends of the inner pipe of the refrigerant heating apparatus assembly to a copper refrigerant piping of the refrigerant circuit; therefore, because the inner pipe is made of copper, which is the same type of material as that of the other refrigerant pipings, it becomes easy to couple the pipings. Accordingly, because metals of the same type are connected to one another, there is no longer any risk that cracks will be created in the brazed parts as a result of the expansion/contraction rate owing to temperature changes, which improves reliability. As a result, it becomes easy to manufacture the air conditioner, which makes it possible to improve the work efficiency and the reliability of the pipings.

A refrigerant heating apparatus assembly attaching structure according to a fifth aspect of the present invention is the attaching structure according to the fourth aspect of the present invention, wherein the refrigerant circuit comprises: a compressor; an accumulator, which is connected to an inlet side of the compressor and is for separating the air and liquid of a refrigerant; a four way switching valve; an indoor heat exchanger; an expansion valve; and an outdoor heat exchanger. The refrigerant heating apparatus assembly is connected to an inlet side of the accumulator.

Here, the refrigerant heating apparatus assembly is connected to the inlet side of the accumulator inside the refrigerant circuit, which makes it possible to dispose the refrigerant heating apparatus assembly spaced apart from and above any heavy objects as well as the large capacity accumulator, the compressor, and the like, which is preferable from the standpoint of the layout of the outdoor unit.

### BRIEF DESCRIPTION OF THE DRAWINGS

FIG. 1 is a circuit diagram of an air conditioner wherein an IH heater assembly according to an embodiment of the present invention is attached.

FIG. 2 is an enlarged oblique view of a machine chamber portion of an outdoor unit in FIG. 1.

FIG. 3 is a front view of the IH heater assembly in FIG. 1.

FIG. 4 is a cross sectional view of the IH heater assembly in FIG. 1.

FIG. 5 is a cross sectional explanatory view that shows an inserting process in a method of manufacturing the IH heater assembly in FIG. 1.

FIG. 6 is a cross sectional explanatory view that shows a pipe expanding process in the method of manufacturing the IH heater assembly in FIG. 1.

FIG. 7 is a cross sectional explanatory view that shows a bobbin mounting process in a method of manufacturing the IH heater assembly in FIG. 1.

FIG. 8 is a cross sectional explanatory view that shows the brazing of the IH heater assembly in FIG. 1.

### DESCRIPTION OF EMBODIMENTS

Next, an embodiment of the refrigerant heating apparatus assembly and an attaching structure thereof according to the present invention will be explained, referencing the drawings.

### Embodiment

### <Basic Configuration>

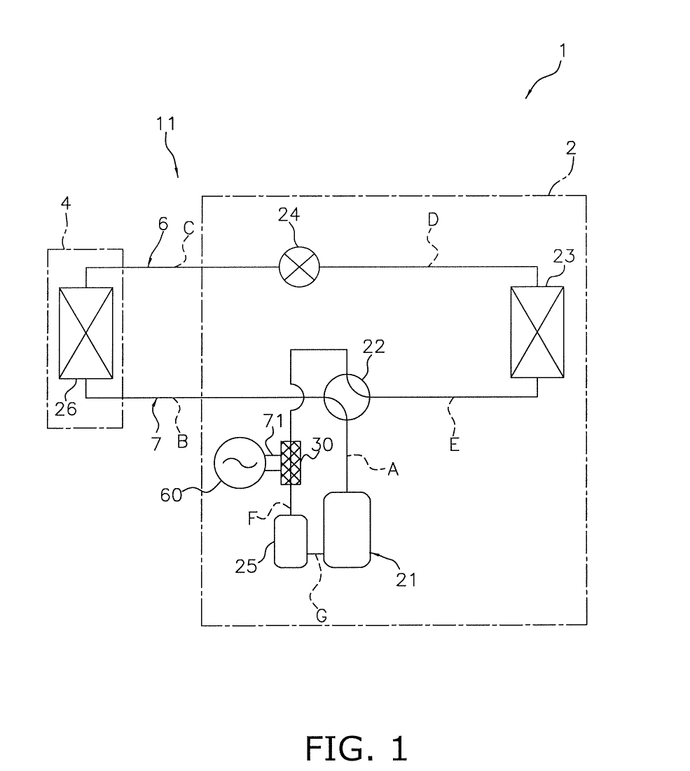

As shown in FIG. 1, an air conditioner 1 that comprises a refrigerant heating apparatus assembly 30 (hereinbelow, called an IH heater assembly 30) comprises a refrigerant circuit 11 that comprises an outdoor unit 2 and an indoor unit 4, which are connected by a liquid refrigerant connecting piping 6 and a gas refrigerant connecting piping 7. Each of the refrigerant pipings 6, 7 of the refrigerant circuit 11 is normally made of copper.

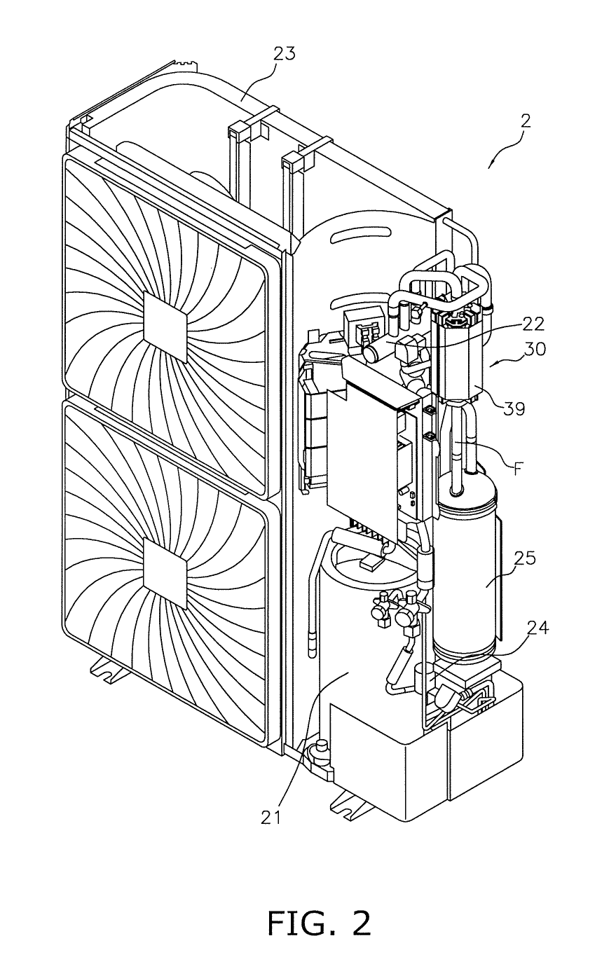

As shown in FIG. 1 and FIG. 2, the section of the refrigerant circuit 11 disposed inside the outdoor unit 2 comprises a compressor 21, a four-way switching valve 22, an outdoor heat exchanger 23, an expansion valve 24 that consists of an electronic expansion valve with an adjustable aperture, the IH heater assembly 30, an accumulator 25, and the like. In addition, as shown in FIG. 1, the section of the refrigerant circuit 11 disposed inside the indoor unit 4 comprises an indoor heat exchanger 26 and the like. Furthermore, FIG. 1 shows the four-way switching valve 22 is switched to the connection state wherein heating operation is performed.

Here, the refrigerant that flows inside the refrigerant circuit 11 is not particularly limited in the present invention and is, for example, HFC (R410A and the like) or CO₂ refrigerant.

As shown in FIG. 1, the refrigerant circuit 11 comprises a discharge pipe A, an indoor side gas pipe B, an indoor side liquid pipe C, an outdoor side liquid pipe D, an outdoor side gas pipe E, an accumulator pipe F, and a suction pipe G.

The text below explains the connection state of each of the refrigerant pipes A-G in the order in which the refrigerant discharged from the compressor 21 flows out of and is then once again sucked into the compressor 21.

The discharge pipe A connects the discharge side of the compressor 21 and the four-way switching valve 22.

The indoor side gas pipe B connects the four-way switching valve 22 and the gas side of the indoor heat exchanger 26.

The indoor side liquid pipe C connects the liquid side of the indoor heat exchanger 26 and the expansion valve 24. Here, the indoor side liquid pipe C comprises the liquid refrigerant connecting piping 6, which brings the outdoor unit 2 and the indoor unit 4 into communication.

The outdoor side liquid pipe D connects the expansion valve 24 and the liquid side of the outdoor heat exchanger 23.

The outdoor side gas pipe E connects the gas side of the outdoor heat exchanger 23 and the four-way switching valve 22.

The accumulator pipe F connects the four-way switching valve 22 and the accumulator 25.

The suction pipe G connects the accumulator 25 and the inlet side of the compressor 21.

The refrigerant circuit 11 is configured in this manner and heating operation can be performed by the flow of the refrigerant such that it circulates in the direction discussed above. Furthermore, cooling operation can be performed by switching the connection state of the four-way switching valve 22.

Somewhere along the accumulator pipe F, the IH heater assembly 30, which is discussed below, is connected by brazing.

### <Configuration of the IH Heater Assembly 30>

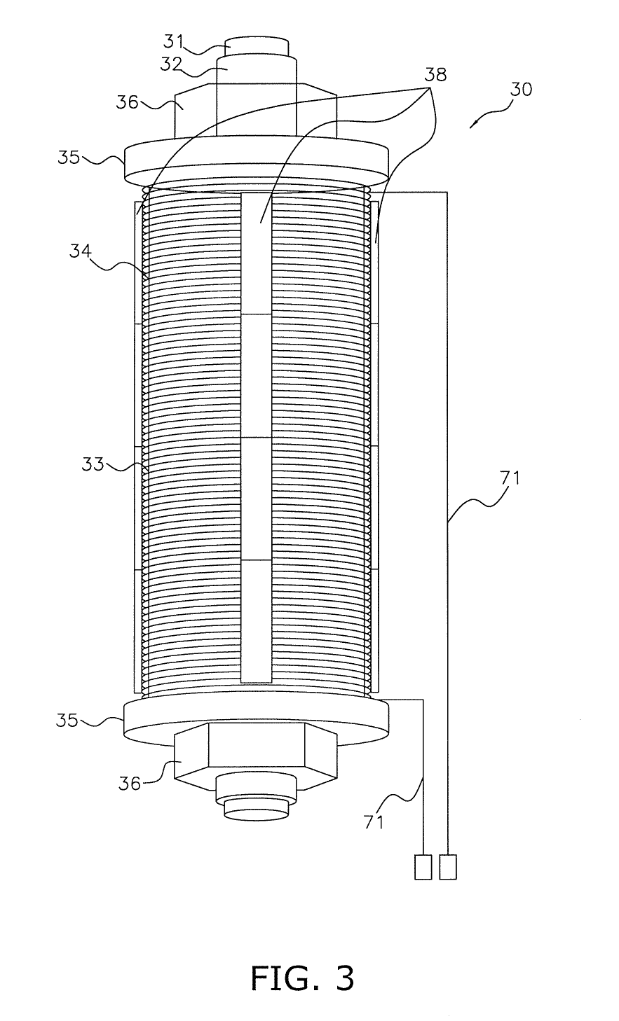

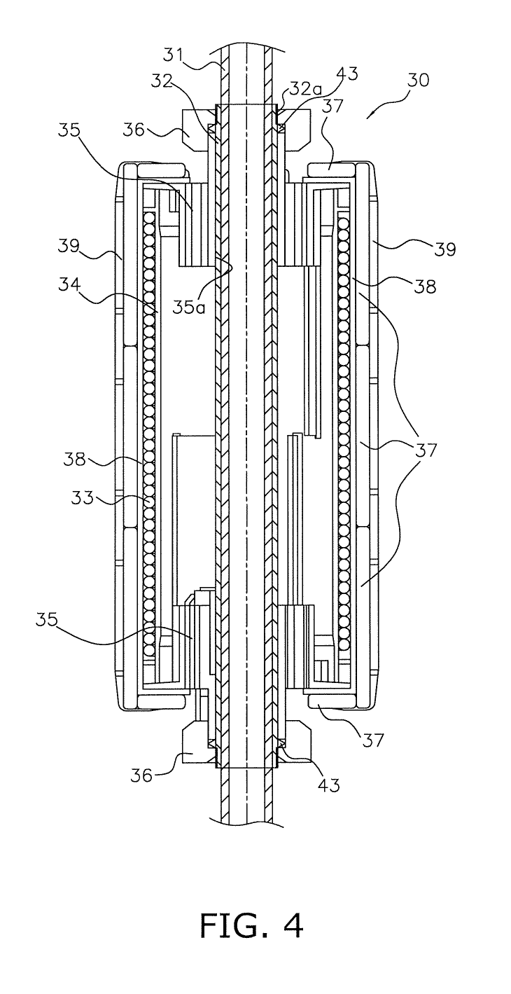

As shown in FIG. 3 and FIG. 4, the IH heater assembly 30 is a double pipe IH heater and comprises an inner pipe 31, an outer pipe 32, an induction heating coil 33, a bobbin 34, a pair of covers 35, a pair of nuts 36, a plurality of ferrite blocks 37, ferrite holders 38, and a sheet metal cover 39.

The inner pipe 31 is made of copper, which is the same material as that of a refrigerant piping A-G, and the refrigerant flows therewithin.

The outer pipe 32 is made of stainless steel, which is magnetic, and is disposed such that it surrounds the inner pipe 31. Specifically, the outer circumferential surface of the inner pipe 31 and the inner circumferential surface of the outer pipe 32 are tightly sealed by expanding the inner pipe 31. The wall thickness of the outer pipe 32 is 1-1.2 mm such that an effective induction heating is obtained by the skin effect (i.e., the phenomenon wherein, when a high frequency current flows through a conductor, the electric current density is high at the conductor surface and decreases as the distance from the surface increases).

Furthermore, the material of the outer pipe 32 is not limited to stainless steel, and can be, for example, a conductor such as iron, copper, aluminum, chrome, nickel, and the like, or an alloy containing at least two metals selected from that group. In addition, the stainless steel may be, for example, a ferrite type or a martensite type, or a combination thereof.

The induction heating coil 33 surrounds and inductively heats the outer pipe 32. In the state wherein the induction heating coil 33 is wound around the bobbin 34, which is a separate member from the outer pipe 32, the induction heating coil 33 is disposed such that it surrounds the outer circumference of the outer pipe 32.

The bobbin 34 is a cylindrical member that is open on both ends; furthermore, the induction heating coil 33 is wound around the side circumferential surface of the bobbin 34.

Each cover of the pair of covers 35 has an opening 35a at the center and is mated to the outer circumference of the outer pipe 32. In addition, in the state wherein the pair of covers 35 is attached to the bobbin 34, the pair of covers 35 is fixed from both sides, above and below, by the C-shaped ferrite holders 38, which are discussed below.

The pair of nuts 36 screw into male thread parts 32a, which are formed on the outer circumference of the outer pipe 32 in the vicinities of both ends of the outer pipe 32, and thereby the bobbin 34, the covers 35, the ferrite holders 38, and the nuts 36 of the IH heater assembly 30, which are assembled in advance, are fixed to the outer circumference of the outer pipe 32.

To reduce leakage magnetic flux to the outer side of the sheet metal cover 39 of the IH heater assembly 30, the plurality of ferrite blocks 37 are arrayed and attached to the C-shaped ferrite holders 38. The ferrite holders 38 are attached outwardly from the induction heating coil 33 on all sides (in four directions) of the bobbin 34.

The sheet metal cover 39 is a cover that consists of sheet metal and is screwed to the outer sides of the ferrite holders 38. The sheet metal cover 39 is shaped such that it surrounds the cylindrical bobbin 34 and may be cylindrical or polygonal; furthermore, it may be an integral body or split into two or more portions.

Thereby, because the inner pipe 31 is made of copper, which is the same type of metal as that of the refrigerant piping F, the inner pipe 31 and the refrigerant piping F can be coupled easily (i.e., they can be manufactured easily). Moreover, the outer pipe 32, which is a magnetic body such as stainless steel, can be inductively heated effectively.

In addition, because a structure is adopted wherein the thick outer pipe 32 supports the bobbin 34 around which the induction heating coil 33 is wound, the strength of the entire IH heater assembly 30 is improved.

Thus, as shown in FIG. 1, providing the IH heater assembly 30 somewhere along the accumulator pipe F that connects the four-way switching valve 22 and the accumulator 25 makes it possible for the IH heater assembly 30, which receives a high frequency alternating current from a high frequency power supply 60 via power supply lines 71, to warm the gas refrigerant suctioned from the four-way switching valve 22 to the accumulator 25, which improves heating capacity.

In addition, even if the compressor 21 is not sufficiently warmed up when heating operation is started up, the gas refrigerant that flows from the four-way switching valve 22 to the accumulator 25 can be heated by heat generated by the IH heater assembly 30, which makes it possible to compensate for insufficient performance at startup.

Furthermore, if the four-way switching valve 22 is switched to the cooling operation state and defrosting operation is performed to eliminate frost adhered to the outdoor heat exchanger 23, then the gas refrigerant that passes through and is warmed by the IH heater assembly 30 can be further compressed by the compressor 21, which makes it possible to increase the temperature of the hot gas discharged from the compressor 21. Thereby, the time needed by the defrosting operation to thaw the frost can be shortened. Thereby, even if it is necessary to perform defrosting operation in a timely manner during heating operation, heating operation can be resumed as quickly as possible, which makes it possible to improve the user's comfort.

### <Method of Manufacturing the IH Heater Assembly 30>

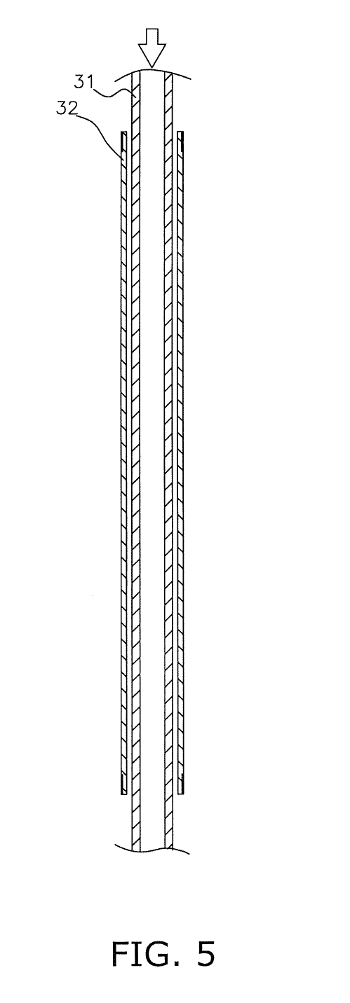

When the IH heater assembly 30 of the present embodiment is manufactured, first, as shown in FIG. 5, the copper inner pipe 31 that constitutes part of the refrigerant piping A-G of the refrigerant circuit 11 is inserted into the stainless steel outer pipe 32 (i.e., an inserting process), which is a magnetic body.

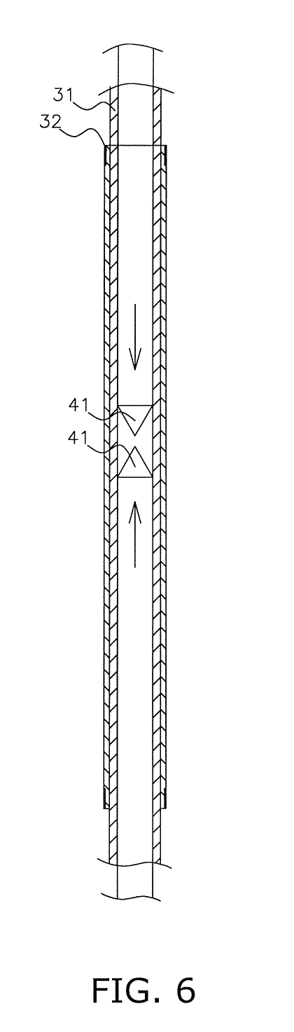

Furthermore, as shown in FIG. 6, pipe expanding billets 41, which have outer diameters somewhat larger than the inner diameter of the inner pipe 31, are inserted under pressure into the inner pipe 31, which enlarges the inner pipe 31 in directions that increase the outer diameter, thereby mating the inner pipe 31 to the inner side of the outer pipe 32 (i.e., a pipe expanding process).

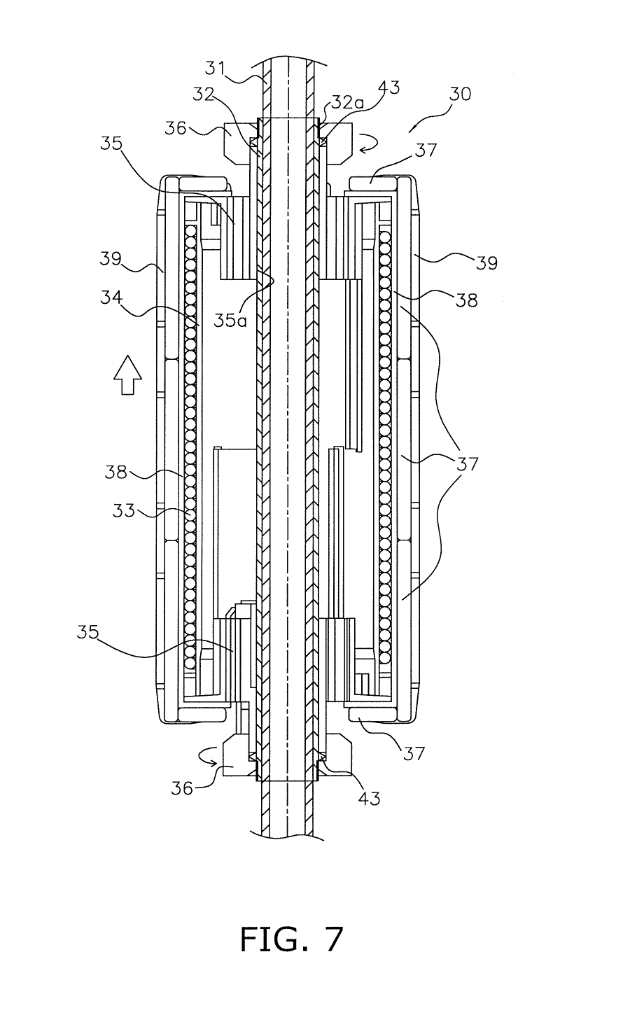

Subsequently, as shown in FIG. 7, the bobbin 34, the covers 35, the ferrite holders 38, and the nuts 36 of the IH heater assembly 30, which are assembled in advance, are mounted onto the outer circumference of the outer pipe 32 in the state wherein the nuts 36 are warmed; subsequently, the nuts 36 are tightened against the outer pipe 32, which presses the nuts 36 against C-shaped rings 43 in the inner diameter direction, and thereby the bobbin 34 and other principal parts are mounted (i.e., a bobbin mounting process). Thereby, the fabrication of the IH heater assembly 30 is complete.

### <Attaching Structure of the IH Heater Assembly 30>

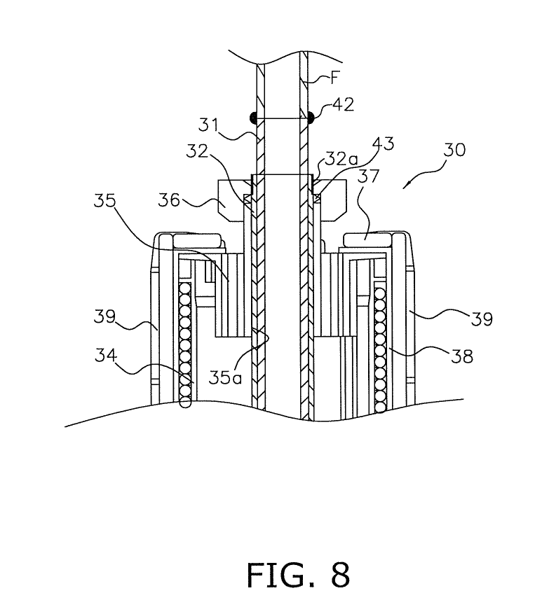

As shown in FIG. 8, the IH heater assembly 30 is attached to the refrigerant circuit 11 at both the upper and lower ends of the inner pipe 31 by brazing alloy 42, which are brazed along the accumulator pipe F of the copper refrigerant pipings A-G of the refrigerant circuit 11. Furthermore, although not shown in FIG. 8, brazing is performed in a similar manner at the lower end of the inner pipe 31.

Thereby, because materials of the same type are brazed to one another, it becomes easier to couple the inner pipe 31 and the accumulator pipe F (i.e., manufacturing becomes easier); moreover, effective induction heating is possible.

In addition, because the IH heater assembly 30 is connected to the inlet side at the upper end of the accumulator 25 via the accumulator pipe F, the IH heater assembly 30 can be disposed above the accumulator 25.

### <Characteristics of the Embodiment>

(1)

In the IH heater assembly 30 of the present embodiment, the copper inner pipe 31, which constitutes part of the refrigerant pipings A-G of the refrigerant circuit 11, is inserted into the stainless steel outer pipe 32, which is a magnetic body, and the inner pipe 31 is enlarged in directions in which its outer diameter enlarges; thereby, the induction heating coil 33, which is wound around the bobbin 34, is mated to the interior of the outer pipe 32 at the outer circumference of the outer pipe 32.

Thereby, because the inner pipe 31 is made of copper, which is the same type of material as that of the other refrigerant pipings A-G, it becomes easy to couple the inner pipe 31 with the accumulator pipe F of the refrigerant pipings A-G. Accordingly, because metals of the same type are connected to one another, there is no longer any risk that cracks will be created in the brazed parts as a result of the expansion/contraction rate owing to temperature changes, which improves reliability. As a result, it becomes easy to manufacture the air conditioner 1, which makes it possible to improve the work efficiency and the reliability of the pipings A-G.

Moreover, the stainless steel outer pipe 32, which is a magnetic body, enables effective induction heating.

In addition, in the present embodiment, a structure is adopted wherein the induction heating coil 33 is mounted to the outer circumference of the outer pipe 32, specifically, the thick outer pipe 32 supports the bobbin 34, around which the induction heating coil 33 is wound; therefore, the strength of the entire IH heater assembly 30 is improved.

(2)

In addition, in the IH heater assembly 30 of the present embodiment, the outer pipe 32 is made of stainless steel, which makes it possible to perform induction heating more effectively than when a pipe of some other magnetic material is used, for example, iron; moreover, it is also advantageous from the perspective of increased strength and a longer lifespan.

(3)

In addition, in the IH heater assembly 30 of the present embodiment, the wall thickness of the outer pipe 32 is 1-1.2 mm, and therefore effective induction heating is obtained owing to the skin effect.

(4)

In addition, in the attaching structure of the IH heater assembly 30 of the present embodiment, as shown in FIG. 8, the IH heater assembly 30 is attached to the refrigerant circuit 11 by brazing both the upper and lower ends of the inner pipe 31 to the accumulator pipe F of the copper refrigerant pipings A-G of the refrigerant circuit 11 with the brazing alloy 42. Thereby, because materials of the same type are brazed to one another, it becomes easy to couple the inner pipe 31 and the accumulator pipe F; as a result, it becomes easy to manufacture the air conditioner 1 and, moreover, efficient induction heating is enabled.

(5)

In addition, in the attaching structure of the IH heater assembly 30 of the present embodiment, the IH heater assembly 30 is connected to the inlet side at the upper end of the accumulator 25 via the accumulator pipe F, which makes it possible to dispose the IH heater assembly 30 spaced apart from and above any heavy objects as well as the large capacity accumulator 25, the compressor 21, and the like, which is preferable from the standpoint of the layout of the outdoor unit 2.

### Modified Examples

### (A)

As an example of a structure wherein the induction heating coil 33 is mounted to the outer circumference of the outer pipe 32, the above embodiment describes a structure wherein the induction heating coil 33 is wound in a spiral around the entire circumference of the bobbin 34, but the present invention is not limited thereto; for example, the winding of the induction heating coil 33 may be disposed spirally over the entire area or just part of the area (e.g., half the area) of the outer circumferential surface of the bobbin 34. In this case, part or the entire prescribed area of the outer pipe 32 can be induction heated. In addition, even if the induction heating coil 33 is mounted to the outer circumference of the outer pipe 32 in this manner, the strength of the entire IH heater assembly 30 is improved.

### INDUSTRIAL APPLICABILITY

The present invention can be adapted variously to the field of designing refrigerant heating apparatus assemblies and attaching structures thereof.

### REFERENCE SIGNS LIST

1 Air conditioner
2 Outdoor unit
4 Indoor unit
6 Liquid refrigerant connecting piping
7 Gas refrigerant connecting piping
11 Refrigerant circuit
21 Compressor
22 Four-way switching valve
23 Outdoor heat exchanger
24 Expansion valve
25 Accumulator
26 Indoor heat exchanger
30 IH heater assembly (refrigerant heating apparatus assembly)
31 Inner pipe
32 Outer pipe
33 Induction heating coil
34 Bobbin
35 Cover
36 Nut
37 Ferrite block
38 Ferrite holder
39 Sheet metal cover
41 Pipe expanding billet
A Discharge pipe
B Indoor side gas pipe
C Indoor side liquid pipe
D Outdoor side liquid pipe
E Outdoor side gas pipe
F Accumulator pipe
G Suction pipe

### Citation List

### Patent Literature

### Patent Document 1

Japanese Unexamined Patent Application Publication No. 2001-174054

1. A refrigerant heating apparatus assembly comprising:
a magnetic outer pipe;
a copper inner pipe inserted into the magnetic outer pipe, the copper inner pipe being expanded such that an outer diameter of the copper inner pipe enlarges and thereby is mated to an interior of the magnetic outer pipe, the copper inner pipe configured to form part of a refrigerant piping of a refrigerant circuit; and
an induction heating coil mounted to an outer circumference of the magnetic outer pipe.

2. A refrigerant heating apparatus assembly according to claim 1, wherein
the magnetic outer pipe is made of stainless steel.

3. A refrigerant heating apparatus assembly according to claim 1, wherein
a wall thickness of the magnetic outer pipe is 1-1.2 mm.

4. A refrigerant heating apparatus assembly attaching structure including the refrigerant heating apparatus assembly according to claim 1 attached to the refrigerant circuit by brazing ends of the copper inner pipe of the refrigerant heating apparatus assembly to a copper refrigerant piping of the refrigerant circuit.

5. A refrigerant heating apparatus assembly attaching structure according to claim 4, wherein
the refrigerant circuit includes
a compressor,
an accumulator connected to an inlet side of the compressor and configured to separate gas and liquid of a refrigerant,
a four way switching valve,
an indoor heat exchanger,
an expansion valve, and
an outdoor heat exchanger; and
the refrigerant heating apparatus assembly is connected to an inlet side of the accumulator.

6. A refrigerant heating apparatus assembly according to claim 2, wherein
a wall thickness of the magnetic outer pipe is 1-1.2 mm.

7. A refrigerant heating apparatus assembly attaching structure including the refrigerant heating apparatus assembly according to claim 2 attached to the refrigerant circuit by brazing ends of the copper inner pipe of the refrigerant heating apparatus assembly to a copper refrigerant piping of the refrigerant circuit.

8. A refrigerant heating apparatus assembly attaching structure according to claim 7, wherein
the refrigerant circuit includes
a compressor,
an accumulator connected to an inlet side of the compressor and configured to separate gas and liquid of a refrigerant,
a four way switching valve,
an indoor heat exchanger,
an expansion valve, and
an outdoor heat exchanger; and
the refrigerant heating apparatus assembly is connected to an inlet side of the accumulator.

9. A refrigerant heating apparatus assembly attaching structure including the refrigerant heating apparatus assembly according to claim 3 attached to the refrigerant circuit by brazing ends of the copper inner pipe of the refrigerant heating apparatus assembly to a copper refrigerant piping of the refrigerant circuit.

10. A refrigerant heating apparatus assembly attaching structure according to claim 9, wherein
the refrigerant circuit includes
a compressor,
an accumulator connected to an inlet side of the compressor and configured to separate gas and liquid of a refrigerant,
a four way switching valve,
an indoor heat exchanger,
an expansion valve, and
an outdoor heat exchanger; and
the refrigerant heating apparatus assembly is connected to an inlet side of the accumulator.
